(19) United States
(12) Patent Application Publication
(10) Pub. No.: US 2006/0054546 A1
(43) Pub. Date: Mar. 16, 2006

(54) Device hermetically sealing a filtering system

(75) Inventors: Kurt Harnack, Tangstedt (DE); Kirsten Schicke, Kaltenkirchen (DE)

Correspondence Address: RANKIN, HILL, PORTER & CLARK LLP, 4080 ERIE STREET, WILLOUGHBY, OH, 44094-7836, US

(73) Assignee: EPPENDORF AG, Hamburg (DE)

(21) Appl. No.: 11/225,584

(22) Filed: Sep. 13, 2005

(30) Foreign Application Priority Data
Sep. 15, 2004 (DE) 10 2004 045 054.4

(51) Int. Cl. B01D 35/30

(52) U.S. Cl. 210/232

(57) ABSTRACT

A device covering in suction-proof, i.e. hermetic manner a filtering system that includes, in the form of one flat composite structure, jointly manufactured reaction vials. Each of the reaction vials have an upper aperture and a lower aperture, with the, upper apertures being situated substantially in an upper surface of the filtering system. The, device is fitted with a resiliently deforming mat that may be mounted flat on the filtering system, only the reaction vials situated in a partial surface zone of the filtering system being hermetically covered when the mat is mounted on the upper filtering system surface. The mat is mounted flat on the underside of a rigid plate having dimensions matching the upper surface of the filtering system. The mat is designed in a manner such that, when the plate is mounted on the top surface of the filtering system, the mat sealingly engages both upper wall regions of the upper apertures and/or the regions of the filtering system surrounding the upper apertures such that no air can flow between the mat and the filtering system between the apertures when vacuum is applied to the lower apertures.

### BACKGROUND OF THE INVENTION

1. Field of the Invention

The present invention relates to filtering systems and, more specifically, devices for hermetically covering reaction vials of a filtering system.

2. Description of Related Art

Devices of this kind are used in the parallel processing of several liquid samples using vacuum filtration in filtering systems comprising several reaction vials formed in a common flat composite structure. Illustratively such filtering systems typically are microtitration filter trays which may comprise in the manner of conventional microtitration plates for instance 96 or 384 reaction vials, also called wells. Contrary to the case of microtitration trays, the reaction vials used in microtitration filter trays are fitted with an upper and a lower aperture and also with a filter configured between these apertures.

In routine processing, the first step is to pipette sample liquid into the filtering system's reaction vials. Thereupon, the lower apertures are vacuum-loaded and the sample liquid is aspirated through the filters. A collecting unit to receive the aspirated liquid is provided as a rule underneath the filtering system. When processing by means of microtitration filter trays, one microtitration tray for instance may be put in place to catch the aspirated liquid.

In general a vacuum chamber is used to produce a vacuum and it may receive the filtering system in a manner that the upper apertures are substantially freely accessible while the lower apertures are subjected to the vacuum produced in the chamber.

Inevitably, problems are encountered when some of the reaction vials of the filtering system are devoid of sample liquid. In that event the unfilled reaction vials may cause an air leak degrading the applied vacuum. That is, the required partial vacuum is not attained because the empty vials offer a lower flow impedance.

It is known to avoid such an air leak for instance by sealing off, in an adhesive manner, the upper apertures of the unfilled vials.

Alternatively, the German patent document DE 101 42 960 describes a resiliently deforming sealing mat designed such that, when lying flat on the filtering system, it shall selectively seal off in suction-proof, i.e. hermetic, manner only the unfilled reaction vials. This effect is substantially attained in that, following vacuum application, initially higher suction prevails in the unfilled reaction vials than in the filled ones. Because of the higher suction, the mat is selectively aspirated against the upper apertures of the unfilled reaction vessels and then seals the unfilled reaction vessels.

### SUMMARY OF THE INVENTION

The present invention is directed toward a device with which to selectively seal off partial zones of the filtering systems while allowing improved automated handling.

The present invention includes a resiliently deforming mat that is configured flat against the underside of a rigid plate having dimensions that match the upper surface of the filtering system. Plates having dimensions matching the filtering system's upper surface may be mounted in problem-free manner on the filtering system. For desirable automated handling, appropriate plates either have dimensions corresponding to the dimensions of the filtering system's upper surface, or, as regards smaller plates, that coincide along one of the surface axes with the upper filtering system surface. Forming the plates in this way permits easy handling of the plates, for instance by means of the gripper element of a work station.

The mat used in the present invention and held against the plate is designed such that when the plate is mounted on the filtering system, the mat shall become sealing in a way that, upon vacuum having been applied to the lower apertures, no air may flow between the mat and the filtering system between the upper apertures.

In the simplest case the mat used in the invention additionally covers the reaction vials' upper apertures and then seals them off directly.

As regards the danger of contamination, the invention advantageously uses a mat with a plane surface. Accordingly, the mat does not enter, or enters only slightly, the reaction vials. Conceivably, however, the mat may be fitted with protrusions which, when the mat is mounted on the filtering system, shall rest in a sealing manner against the reaction vials' upper inner wall zones.

It is understood that as regards the above described design, the mat size must be matched to the size of the desired filtering surface partial zone that must be covered. That is, regarding the zones where sealing is not desired, the tray of the device of the invention would not bear a mat at its underside, and these zones would not be jointly covered by the mat.

The design is especially attractive when the device of the invention is prefabricated and held ready for use for different partial surface zones to be covered. Conceivably, for instance, the different devices will be held in defined storage sites of a work station and are preprogrammed so that, depending on the filling status of the filtering system to be covered, they will be selected automatically by the gripper element and then be processed.

The above described designs are especially well suited for large scale operations.

Another embodiment of the invention applies to other applications in that the device may be matched individually to the filtering system's partial surface zones to be covered. In this embodiment, the mat and the plate advantageously correspond by their dimensions to the upper surface of the filtering system to be covered. The mat and the plate include boreholes which, when the plate is mounted on the filtering system's upper surface, allow an airflow to pass from the topside of the tray through the mat into a reaction vial.

Conceivably, as regards this embodiment, the plate comprises a number of boreholes corresponding to the number of reaction vials, while the mats to be connected to the plates are devoid of boreholes in the partial surface zones to be covered of the filtering system. In this instance too, different mats may be used for different filtering system partial surface zones, with the mats in each case being selected in relation to the filter system's filling status, and being affixed to the plate. It is understood that in this case the connection between plate and mat is detachable, rather than permanent.

In another embodiment of the present invention, both the plate and the mat are congruent as regards the number and array of the boreholes and the number and array of the filtering system's reaction vials. Additionally as regards this particular embodiment, a sheet is used which can be mounted on the top plate side to allow hermetically covering the plate boreholes. Again, obviously, a sheet appropriate for a given partial surface zone of the filtering system may be selected from a set of sheets of different sizes and mounted on the top plate side.

This embodiment allows matching in an especially elegant manner the device of the present invention to the size of the surface zone to be sealed off. Contrary to the case of the mat configured at the plate's underside, the sheet used in this design may be comparatively thin. Because the sheet is configured at the plate's top side, theoretically no further device is needed to hold the sheet in place.

It is assumed that the main application of the device of the present invention is the suction-proof or hermetic covering of partial surface zones of microtitration filtering trays. In the typical application, the covered partial surface zones include one or more rows of reaction vials that usually are mutually adjacent. Obviously further, individual covering is also conceivable. Nor may one infer that several, non-contiguous partial surface zones are outside the feasibility of covering.

Obviously too the present invention is not restricted to microtitration filtering tray formats. Other filtering systems are conceivable that contain several reaction vials. Such filtering systems too shall be considered within the scope of this invention.

The concept of “plate” used herein is not limitative. It also includes for instance devices with generic lids.

Advantageously the weight of the plate used in the present invention suffices that, following its being mounted to the filtering system, the mat can be compressed enough that the desired sealing effect can take place following application of vacuum. Basically, the plate should be heavy enough to preclude it from slipping caused by vacuum pump vibrations. Among other applicable materials, the plate may, for instance, be made of steel, aluminum or brass.

Obviously lower-weight plates, also those made from other materials, which per se would not press hard enough against the mat to assure the desired sealing effect, may be used. In this case, such trays will be compressed manually or by the gripper element at the work station until the sealing effect has been implemented.

The plate may, but need not, be fitted with implements to adjust it on the filtering system. Such implements however are not mandatory, and are particularly not mandatory for automated work-station handling.

Illustratively, the mat used in the manner of the present invention may be made of silicone or rubber. Basically, the material and the thickness are selected such that, when mounting the mat on the filtering system and in the presence of applied vacuum, either the apertures of the covered reaction vials shall be sealed directly, or else only one air flow directed through a mat borehole shall be possible in each aperture. Optimally, the mat shall lie in sealing manner against the aperture after vacuum application. However, mats that require a slight compression in addition to the applied vacuum to become effectively hermetic also are adequate, where the additional compression may be exerted, for instance, by the weight of the plate resting on them or also manually for instance by a work-station gripper element. All current elastomers, among which rubber or silicone, particularly with Shore hardnesses between 40 and 60, are appropriate. Suitable thicknesses illustratively are in the range from 0.5 to 1 mm. Obviously other hardnesses or thicknesses also may be selected.

### BRIEF DESCRIPTION OF THE DRAWINGS

These and further features of the invention will be apparent with reference to the following description and drawings, wherein:

FIG. 1 shows an illustrative embodiment of the device of the invention,

FIG. 2 shows a further embodiment, and

FIGS. 3a-c are top views of the embodiment of FIG. 2, each applying to sealing off different partial zones.

### DETAILED DESCRIPTION OF THE PREFERRED EMBODIMENTS

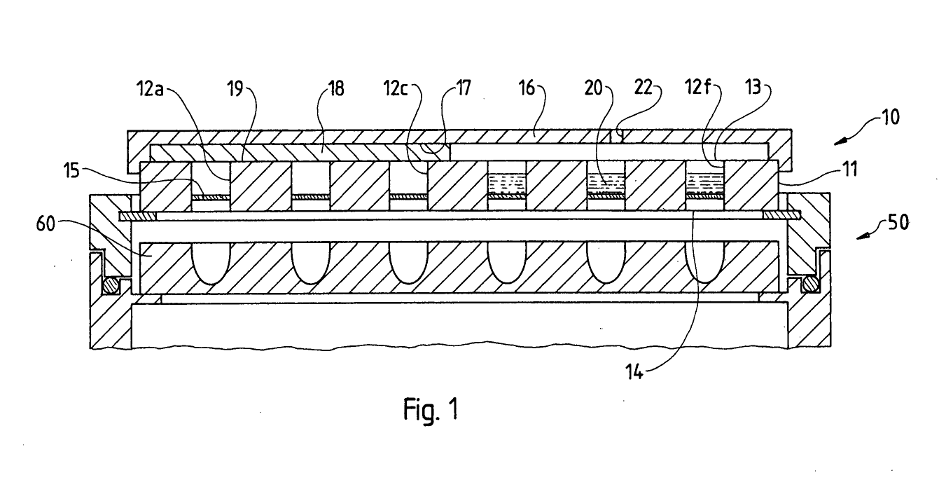

FIG. 1 shows an embodiment of the device 10 of the invention when deposited on the filtering system (in this instance, as shown, a microtitration filtering tray 11).

The microtitration filtering tray comprises several reaction vials 12a-f of which, for the sake of clarity, only vials 12a, c and f are referenced. Each reaction vial 12a-f comprises an upper aperture 13 and a lower aperture 14. Moreover, a filter 15 is present in the region of the lower aperture in the reaction vials 12a-f.

The device 10 of the invention comprises a plate 16 which, in this instance, is a cover that can be deposited on the microtitration filtering tray 11. The plate 16 may be fitted with a borehole 22 allowing air inflow upon application of vacuum. Conceivably however, plates may be used that will rest on the microtitration filtering trays in less than a hermetically sealed manner. A resiliently deforming mat 18 is mounted to the underside 17 of the plate 16 and rests in a suction-proof, i.e. hermetic, manner in a partial surface zone 19 of the filtering tray 11 against zones 19 enclosing and sealing off the apertures 13 of the unfilled reaction vials 12a-12c.

The mat 18 does not cover the reaction vials 12d-f that are filled with liquid 20.

The microtitration filtering tray 31 is inserted into a vacuum chamber 50 not otherwise shown in detail that also receives a microtitration tray 60 configured underneath the microtitration tray 11 and collecting the filtered liquid. Such a vacuum chamber being commercially and well known to the expert therefore is not shown in detail herein.

Upon applying a vacuum to the lower apertures 14 of the reaction vials 12a-f, air shall flow only through the vials 12d-f. In this manner air leaks otherwise occurring through the unsealed reaction vials 12a-c are averted in an especially simple manner.

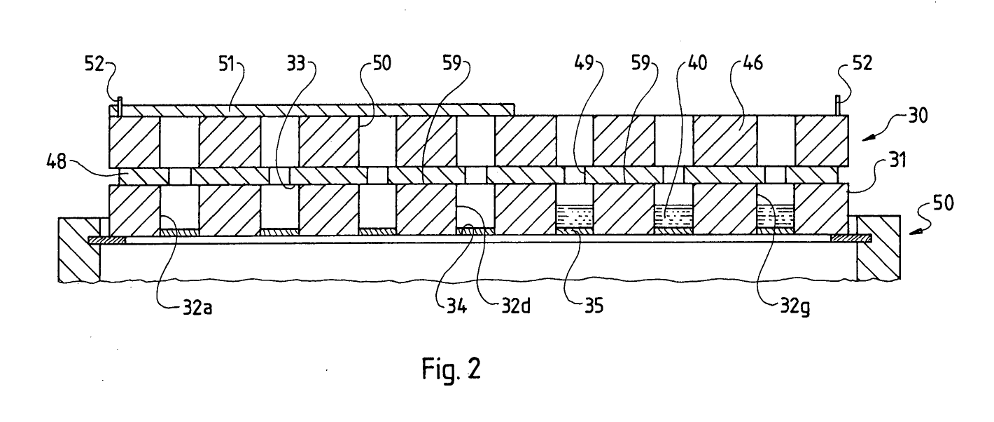

FIG. 2 shows a further embodiment of the invention. The device 30 of the invention is again mounted on a microtitration filtering tray 31.

The microtitration filtering tray 31 again is inserted in the vacuum chamber 50 which is merely indicated in this FIG. 2.

The microtitration filtering tray comprises reaction vials 32a-g of which the vials 32e-32g are filled with liquid 40. The vials 32a-g comprise upper apertures 33 and lower apertures 34, a filter 35 being provided in the region of the lower aperture 34.

The device 30 of the invention comprises a mat 48 mounted on the underside of a plate 46. Boreholes 49 and 50 aligned with the upper apertures 33 of the reaction vials 32a-g are present in the mat 48 and plate 46, and allow air to flow from the top side of the plate 46 into the reaction vials.

In the region of the reaction vials 32a-32d, the boreholes 50 in the plate 46 are covered in a suction-proof, i.e. hermetic, manner by a sheet 51 mounted on the topside of the plate 46. Accordingly, air cannot flow into these reaction vials and again undesired air leaks related to vacuum application are precluded in a simple manner. In theory, the sheet 51 may be mounted absent any fastener element onto the plate 46. However, FIG. 2 also shows one of several pins 52, which are designed to prevent the sheet 51 from slipping laterally. In this embodiment and as shown, the mat rests in a hermetically sealing manner both against the filtering system surface at the areas 59 around the apertures and against the plate underside.

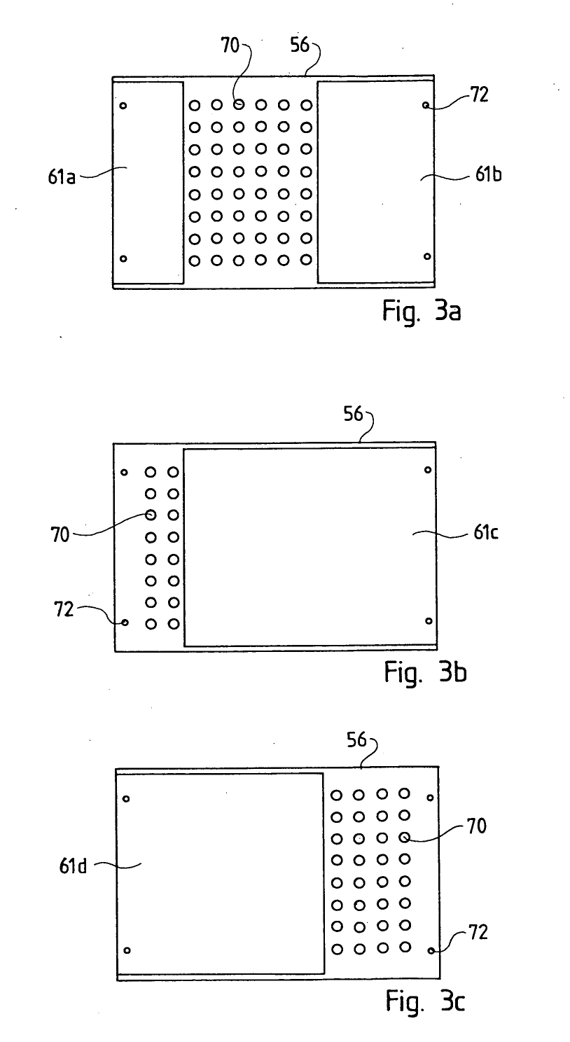

It is understood that the sheet 51 may be exchanged in an especially simple manner with other sheets of different dimensions. This feature is illustrated in FIGS. 3a-c that show different sheets 61a-d, each mounted on a plate 56 and held in place by pins 72. Contrary to the basic designs illustrated in FIGS. 1 and 2, the plates shown in FIGS. 3a-c exhibit boreholes 70 corresponding in number and configuration to a conventional 96 vial microtitration filtering tray format.

Again it is understood that a plurality of different partial surface zones may be covered already with the four sheets 61a-d of different sizes.

1. A device covering in suction-proof, i.e. hermetic manner, a filtering system that comprises—in one flat composite structure—jointly manufactured reaction vials each having an upper and lower aperture, the upper apertures being situated substantially in an upper surface of the filtering system, said device being fitted with a resiliently deforming mat that may be mounted flat on said filtering system, only the reaction vials situated in a partial surface zone of the filtering system being hermetically covered when said mat is mounted on the upper filtering system surface,
characterized in that
the mat (18, 48) is mounted flat on the underside (17, 47) of a rigid plate (16, 46, 56) of which the dimensions match the upper surface of the filtering system (11, 31), and the mat (18, 48) is designed in a manner that when the plate (16, 46, 56) is mounted on the top surface of the filtering system (11, 31), said mat shall engage in sealing manner both the upper wall regions of the upper apertures (13, 33) and/or the regions (19, 59) of the filtering system (11, 31) surrounding the upper apertures whereby no air can flow between the mat (18, 48) and the filtering system (11, 31) between the apertures (13, 33) when vacuum is applied to the lower apertures (14, 34).

2. Device as claimed in claim 1, characterized in that the dimensions of the plate (16, 46, 56) correspond to the upper surface of the filtering system (11, 31).

3. Device as claimed in either of claims 1 and 2, characterized in that the dimensions of the mat (48) correspond to the upper surface of the filtering system (31), boreholes (49, 50, 70) being present in the mat (48) and the plate (46, 56), said boreholes allowing air to flow from the top side of the tray (46, 56) through the mat (48) into each reaction vial (32e-g) when the plate (46, 56) is mounted on the top surface of the filtering system (31).

4. Device as claimed in claim 3, characterized the number and configuration of the boreholes (49, 50) in the mat (48) and in the plate (46) correspond to the number and configuration of the upper apertures (33) of the reaction vials (32a-32g) in the filtering system (31), a sheet (51, 61a-d) being additionally present on the top side of the plate (46, 56), said sheet allowing to hermetically cover the boreholes (50, 70) in the tray (46, 56).

5. Device as claimed in claim 4, characterized in that a set of sheets (61a-d) of different sizes is used for being selectively mounted on the top side of the plate (56).

6. Device as claimed in one of the above claims, characterized in that the filtering system (11, 31) is a microtitration filtering tray.
